(19) United States
(12) Patent Application Publication
(10) Pub. No.: US 2025/0214459 A1
(43) Pub. Date: Jul. 3, 2025

(54) PLUG CONNECTOR PART

(71) Applicant: KIEKERT AKTIENGESELLSCHAFT, Heiligenhaus (DE)

(72) Inventors: Michael BERRES, Köln (DE); Benjamin DJEDOVIC, Oberhausen (DE); Tim SONNENSCHEIN, Wuppertal (DE)

(73) Assignee: KIEKERT AKTIENGESELLSCHAFT, Heiligenhaus (DE)

(21) Appl. No.: 18/851,436

(22) PCT Filed: Mar. 22, 2023
(86) PCT No.: PCT/DE2023/100219

§ 371 Date: Sep. 26, 2024

(30) Foreign Application Priority Data
Apr. 5, 2022 (DE) 10 2022 108 104.4

(51) Int. Cl. B60L 53/16; H01R 13/66

(52) U.S. Cl. CPC B60L 53/16; H01R 13/6683

(57) ABSTRACT

A plug connector part for mechanical and electrical connection to a mating plug connector part, in particular a vehicle-side charging socket for coupling to a charging plug as components of an electrical charging infrastructure for electric or hybrid motor vehicles. For this purpose, the plug connector part is equipped with: a housing; at least one electrical contact element located in the housing; and a temperature-monitoring device having at least one planar carrier element and at least one temperature sensor located thereon for the contact element. The carrier element can be thermally coupled to the contact element with the aid of at least one spring element. According to the invention, the carrier element is positioned tangentially on the contact element.

The invention relates to a plug connector part for mechanical and electrical connection to a mating plug connector part, in particular a motor vehicle-side charging socket for coupling to a charging plug as components of an electrical charging infrastructure for electric or hybrid motor vehicles, or vice versa, with a housing and at least one electrical contact element located in the housing, and with a temperature-monitoring device having at least one planar carrier element and at least one temperature sensor located thereon for the contact element, wherein the carrier element can be thermally coupled to the contact element with the aid of at least one spring element.

The plug connector part is generally a charging socket in a motor vehicle that can be coupled with an associated charging plug-for example, on an electrical charging station. The charging plug (and also the charging socket) is part of an electrical charging infrastructure that can be used to charge the rechargeable energy storage units or accumulators of electric or hybrid motor vehicles. In principle, the plug connector part on the motor vehicle can also be a charging plug instead of a charging socket. In this case, the charging station is equipped with an associated charging socket. As a rule, however, the electric or hybrid motor vehicle has a charging socket with several electrical contact elements, located in the housing, into which the charging plug connected to the charging station is inserted to charge the motor vehicle in question.

In order to be able to supply the high performance of the electric motors in the motor vehicle in question with the necessary electrical energy on the one hand and to provide a sufficient range on the other, high-voltage batteries or accumulators are typically used nowadays, which are typically charged with high-voltage direct current. In addition to such DC (direct current) charging processes, most electric or hybrid motor vehicles also allow the charging process to be carried out via an alternating voltage in the sense of an AC (alternating current) charging process. At this point, however, low currents and long charging times are usually used, whereas, in the DC charging process described above, high voltages and high currents and the resulting short charging times are observed.

In particular with DC charging processes, the fundamental problem is that the electrical contact elements used at this point become increasingly hot due to the high current intensity. This increases their resistance, which hinders the electrical charging process and the desired fast charging.

For this reason, the generic prior art according to EP 3 616 270 B1 describes a plug connector part including a temperature-monitoring device. For this purpose, the temperature-monitoring device has a carrier element extending in a planar manner along a plane, on which carrier element the sensor device or the temperature sensor is located. In addition, the carrier element is equipped with two clip arms, via which the carrier element is clipped onto the contact element whose the temperature is to be monitored.

Another approach according to EP 3 286 804 B1 involves a plug connector part, which is again equipped with a carrier element. With the aid of the carrier element, the detection of a heating on at least one contact element takes place. For this purpose, the contact element extends through at least one opening of the carrier element.

The prior art has generally proven itself when it comes to detecting and evaluating any heating of the contact element of the plug connector part with the aid of the temperature-monitoring device. For this purpose, the temperature-monitoring device is typically connected to a control unit to ensure, for example, rapid shutdown in the event of overheating. This prevents any damage to the plug connector part and in particular to the associated housing, which is usually made of plastic.

However, it is noticeable that the known embodiments of the carrier element generally require a special design with regard to the contact element to be monitored with regard to temperature. This applies in particular to the clips provided in the generic prior art according to EP 3 616 270 B1, with the aid of which the carrier element is clipped onto the contact element. Such clips must be adapted to the geometry of the contact element and can often be connected to the electrical contact element only in a specific assembly position. The invention as a whole seeks to remedy this.

The invention is based upon the technical problem of further developing a plug connector part of the structure described at the outset in such a way that a flexible attachment of the temperature-monitoring device to the electrical contact element to be monitored is possible while taking into account simple assembly.

To solve this technical problem, a generic plug connector part for mechanical and electrical connection with a mating plug connector part in the context of the invention is characterized in that the carrier element is positioned tangentially to the (cylindrical) contact element in a front view of the contact element.

In the context of the invention, the carrier element is therefore not, for example, connected directly to the contact element in order to provide the required thermal coupling and thus temperature monitoring, as is the case in the prior art with the clips according to EP 3 616 270 B1. Rather, the invention relies on a touching contact of the carrier element on the cylindrical contact element in such a way that the carrier element is positioned tangentially on the cylindrical contact element, or the carrier element touches the cylindrical contact element tangentially.

In this way, the carrier element and with it the temperature sensor located on the carrier element can be flexibly attached to the cylindrical contact element. All that is required is that the carrier element touch the contact element tangentially or rest against it. This generally makes it possible to work with different assembly directions, depending upon the installation conditions observed and present. In addition, the design according to the invention expressly does not require a specific adaptation of the carrier element to the geometry of the cylindrical contact element—in contrast to the prior art.

In fact, the diameter of the cylindrical contact element ultimately plays practically no role in the tangential contact of the carrier element. Furthermore, in the context of the invention, it is sufficient if the contact element is cylindrical at least in the contact region with the carrier element, so that the carrier element can be positioned tangentially on the cylindrical contact element or the cylindrical region of the contact element. This gives the contact element a wide range of degrees of freedom in its implementation. The same applies to the plug connector part as such and the associated housing, which the prior art is not able to provide.

According to a further advantageous embodiment, the contact element has on the housing side an insulating collar with an insertion opening for the carrier element.

The invention is based upon the knowledge that a high-voltage direct

current is present at the contact element or the usually two contact elements provided at this point. In order to achieve the appropriate distances and required electrical insulation at this point, the contact element in question is equipped with the insulating collar on the housing side, i.e., inside the housing usually up to a connection region of the contact element. Typically, the contact element is a contact socket, because the plug connector part is usually designed as a motor vehicle-side charging socket.

The insulating collar now ensures that the contact element or contact socket is practically completely covered with the insulating collar except for the insertion opening for the carrier element, so that only a contact plug as a component of the charging plug can be inserted into the contact socket and ensures the required electrical contact. Nevertheless, the carrier element can be easily installed. All that is required is that the carrier element passes through the insertion opening in the insulating collar and is thus placed tangentially on the contact element or its cylindrical region. The at least one spring element or, as a rule, the several spring elements ensure that the carrier element is positioned accordingly and held in contact with the cylindrical contact element inside the insertion opening with the required force.

The insulating collar is usually a component of the housing and, like the housing, may be made of plastic; for example, it may form a one-piece plastic-injection-molded part together with the housing. In principle, the insulating collar can also be provided separately from the housing. In this case, for example, the contact element can be accommodated by the insulating collar, and the assembly arrangement formed in this way can be installed in the housing by means of, for example, ratchets.

In addition, the insertion opening is usually adapted in size to the carrier element or the temperature sensor. This means that the insertion opening typically corresponds in size to the external dimensions of the carrier element or the temperature sensor, so that, when the carrier element is installed in the insertion opening, no uncovered regions of the contact element are observed. This is further enhanced by the fact that the carrier element has a sheath that is both heat-conducting and electrically insulating, so that the contact element is covered in an electrically insulating manner with the aid of the insulating collar and by the carrier element, which is also equipped with the insulating sheath.

The carrier element is typically a sensor board with conductor tracks for the electrical transmission of sensor signals. In fact, at this point, a circuit board made of an electrically non-conductive carrier material, such as plastic, is usually used, which is equipped with printed or embedded conductor tracks. Signals from the temperature sensor can be transmitted via the conductor tracks—for example, to a control unit connected to the carrier element via a supply line.

The temperature sensor is typically a semiconductor sensor or a resistance sensor, which can, for example, have a positive temperature coefficient in the sense of a PTC resistor. In such temperature sensors, the resistance value increases with increasing temperature. Colloquially, these temperature sensors are also called PTC thermistors and can, for example, be made of a ceramic material as so-called ceramic PTC thermistors. It is also conceivable to use electrical resistors with a negative temperature coefficient—so-called NTC resistors—as temperature sensors. In this case, the resistance of the temperature sensor in question decreases as the temperature increases.

As a rule, the temperature sensor is located at the end of the carrier element on its upper or lower side. The carrier element itself is designed as a rectangular strip. By attaching the temperature sensor at the end with respect to the rectangular strip, the temperature sensor can be positioned in such a way that it comes into direct thermal contact with the cylindrical contact element or the cylindrical region of the contact element when the carrier element is located tangentially to the contact element. In principle, however, it is also possible for the temperature sensor to be located not at the end, but, rather, in the middle of the carrier element. In this case, the carrier element may be equipped with a metal core, with the help of which heat is conducted from the contact surface of the carrier element with the contact element to the temperature sensor. In this case, the carrier element is designed as a so-called metal core circuit board, as described in detail in DE 39 35 680 A1. In this case, a metal plate is covered with plastic on the inside, and additional conductor tracks can be applied, e.g., photolithographically, as described in detail in the previously mentioned prior art.

As a rule, however, the sensor board or circuit board made of plastic with applied or embedded conductor tracks and without an additional metal core is used as the carrier element. This is because the temperature sensor located on the carrier element or the circuit board is generally located on the contact surface of the carrier element with the contact element, so that the heat flow emanating from the contact element hits the temperature sensor directly and almost without delay.

At this point, however, the heat flow emanating from the contact element must first pass through the sheath which is usually provided and surrounds the carrier element and which, according to the invention, is designed to be both heat-conducting and electrically insulating. The sheath as a whole is designed in such a way that it encloses the sensor board or circuit board and the temperature sensor together. The sheath is typically a plastic sheath.

For this purpose, the sheath usually relies on a compound which initially uses a thermoplastic such as PA (polyamide), PBT (polybutylene terephthalate), PP (polypropylene), PPS (polyphenylene sulfide), or comparable thermoplastics. These can be processed particularly easily by injection molding. In addition, a filler is added to the plastic or plastic compound in question as a plastic sheath. Graphite, carbon fibers, or ceramics are examples of suitable fillers.

In fact, thermosets or thermoplastics that are equipped with electrically insulating, thermally conductive fillers are advantageously used here. In particular, aluminum compounds or boron compounds, preferably aluminum oxide or boron nitride, have proven to be particularly suitable here. The grammage of these electrically insulating and thermally conductive fillers in the plastic can be up to 50 wt. % and more. Thermal conductivities of more than 1 W/(m·K) up to 25 W/(m·K) can be achieved. Further details with regard to such plastics can be found in the prior art according to DE 10 2007 037 316 A1, which is cited here as a reference. Similar information can be found in DE 10 2013 208 605 A1.

At this point, the invention further recommends that the sheath for the carrier element including the temperature sensor typically have a material thickness of less than 1 mm, in particular of 0.5 mm or less. This provides a very fast heat transfer from the contact element to the temperature sensor, so that any overheating at this point can be detected immediately and can, for example, result in a power cut.

Finally, the invention recommends a special design of the carrier element, viz., one in which the carrier element is equipped with two opposing temperature sensors. In this case, for example, two contact elements for a DC charging process can be temperature monitored simultaneously with a (single) carrier element. It goes without saying that, by using the two opposing temperature sensors, the two contact elements can be monitored separately for any overheating. As soon as signs of such overheating occur and are observed on one of the two contact elements, this is interpreted by the control unit supplied with the sensor signals as a shutdown or a reduction in current. It goes without saying that the two opposing temperature sensors are again located in the region of the contact surface of the carrier element with the associated contact element in order to be able to realize and implement a temperature measurement that is as delay-free as possible.

Finally, the design is usually such that the conductor track or the multiple conductor tracks as components of the carrier element or the sensor board or circuit board realized at this point define one or more contact regions. The sensor signals can now be transmitted to the control unit in a particularly advantageous manner via these contact regions and the spring elements which generally enclose the contact regions on at least one side. It is understood that the contact regions in question are not covered by the sheath of the sensor board including the temperature sensor, so that, when the carrier element is mounted, the spring elements can directly electrically contact the contact regions in question.

This means that, according to the invention, the spring elements perform a dual function, viz., in such a way that, on the one hand, the carrier element in question is held in tangential contact with the contact element to be monitored.

On the other hand, the spring elements also function as electrical contacts, viz., to be able to transmit the sensor signals of the temperature sensor attached to or on the carrier element to the control unit. In principle, it is of course also conceivable and within the scope of the invention that further contact regions be realized at this point, which do not necessarily serve to transport the sensor signals from the temperature sensor.

As a result, a plug connector part and in particular a motor vehicle-side charging socket with temperature-monitoring device is provided and realized, in which the temperature-monitoring device can be adapted particularly flexibly to different installation situations and designs of the charging socket in question. This can essentially be attributed to the fact that the temperature-monitoring device uses at least one planar carrier element, which is positioned tangentially to the cylindrical contact element for this purpose. This means that special fastenings to the contact element or specific assembly directions are not required, which explains the particular flexibility. These are the main advantages.

In the following, the invention is explained in more detail with the aid of a drawing showing only one exemplary embodiment; in the figures:

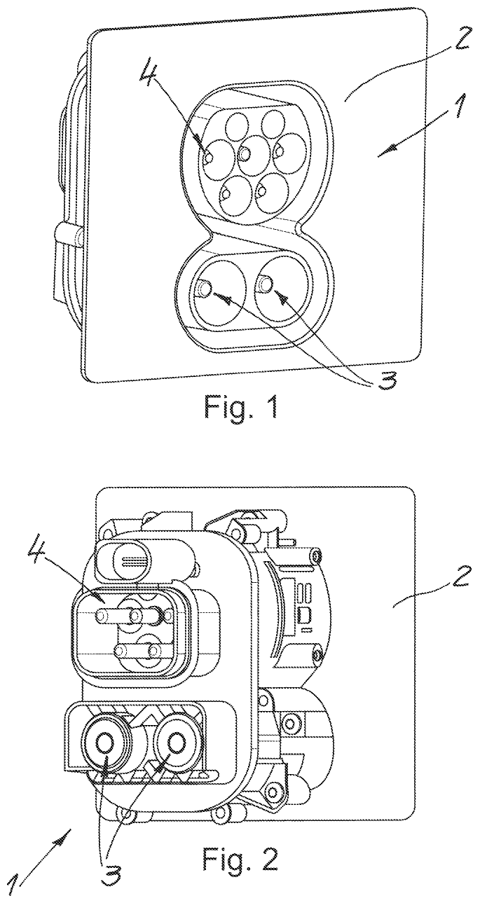

FIG. 1 is a front view of the plug connector part according to the invention in the form of a motor vehicle-side charging socket,

FIG. 2 is the associated rear view to FIG. 1,

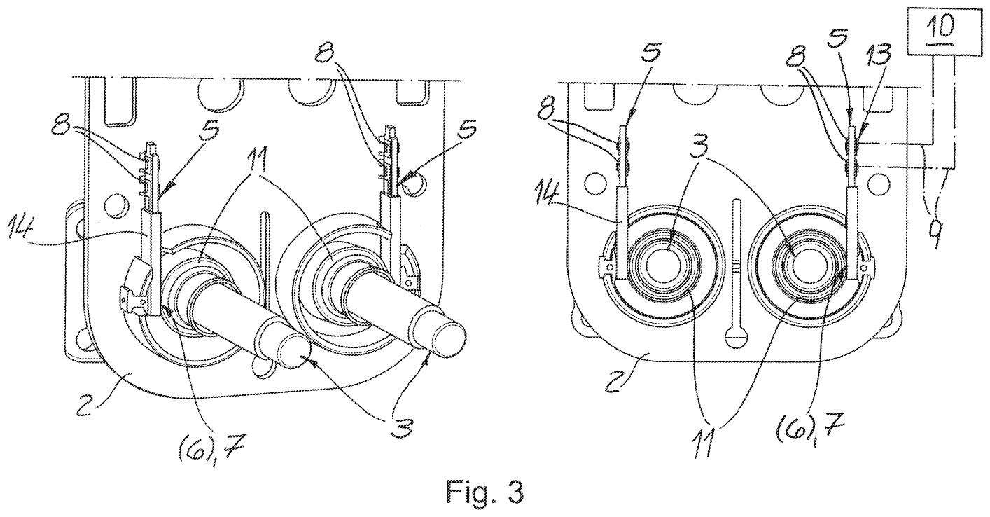

FIG. 3 is an enlarged section of the subject matter shown in FIG. 2, and

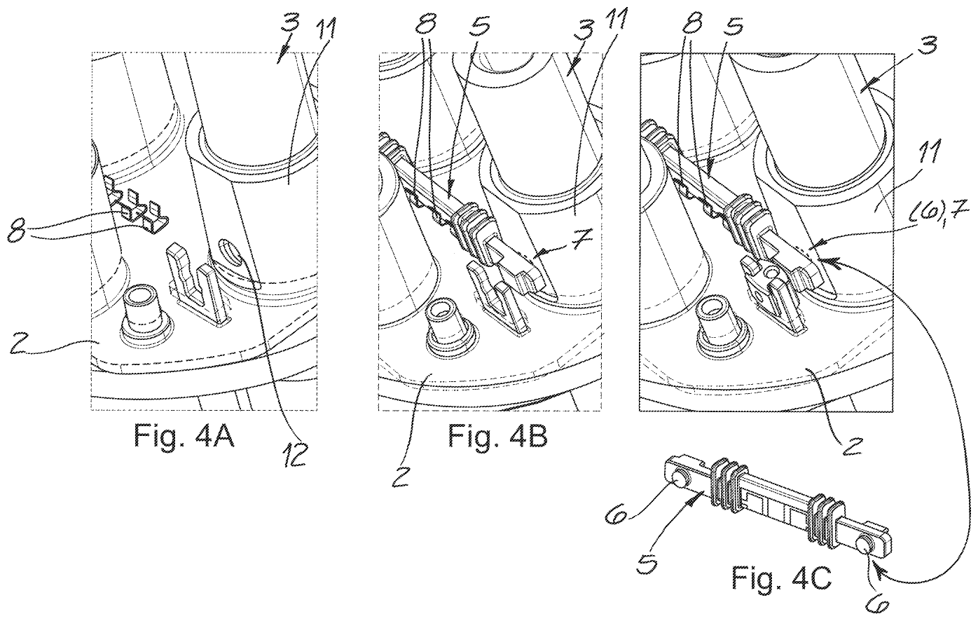

FIGS. 4A to 4C show the assembly of an alternatively used carrier element as a temperature-monitoring device.

The figures show a plug connector part for mechanical and electrical connection with a mating plug connector part. In fact, the plug connector part according to the exemplary embodiment in FIGS. 1 and 2 is a motor vehicle-side charging socket 1. The charging socket 1 is designed to be coupled to a charging plug, which is not shown in detail and is a component of an electrical charging infrastructure for electric or hybrid motor vehicles.

For this purpose, the charging socket 1 is equipped with a housing 2 made of plastic and at least one electrical contact element 3 located in the housing 2. In the following, only the two contact elements 3 required for a DC charging process are considered. The additional electrical contact elements 4 provided are in contrast required for an AC charging process and will not be discussed in more detail below.

As shown in FIGS. 3 and 4, the two contact elements 3 are equipped with a temperature-monitoring device 5, 6. For this purpose, the temperature-monitoring device 5, 6 has at least one planar carrier element 5 and at least one temperature sensor 6 located thereon for the contact element 3.

From FIGS. 3 and 4, it can be seen that the carrier element 5 is planar and designed as a rectangular strip or as a rectangular element. It is also clear that the temperature sensor 6 is located on a surface of the carrier element 5, viz., at the end of the carrier element 5 in the region of a contact surface 7 with the contact element 3.

The carrier element 5 is held with the aid of several spring elements 8, and in this way, it is achieved that the carrier element 5 is thermally coupled with the contact element 3. As shown in FIGS. 4A to 4C, the respective spring elements 8 are U-shaped springs which surround the rectangular carrier element 5 at the edge. According to the exemplary embodiment, the individual spring elements 8 serve not only to hold the carrier element 5, but are additionally connected to electrical lines 9, which are only indicated in FIG. 3 and which in turn are connected to a control unit 10.

According to the invention, the carrier element 5 is positioned tangentially to the contact element 3, specifically in a front view of the contact element 3. For this purpose, the contact element 3 is cylindrical at least in the region of the contact surface 7. This allows the temperature sensor 6 to come into direct thermal contact with the contact element 3.

It can be seen in particular from FIGS. 3 and 4A to 4C that the contact element 3 is, on the housing side, enclosed with an insulating collar 11 which has an insertion opening 12 for the carrier element 5 or the temperature sensor 6 engaging in the insertion opening 12 on the carrier element 5. The insulating collar 11 can also be made of plastic in one piece with the housing 1. In principle, the insulating collar 11 and the contact element 3 can also depict an assembly arrangement 3, 11 that can be pre-assembled, which is connected to the rest of the housing 1—for example, in a snap-in manner. However, this is not shown in detail.

The insertion opening 12 is adapted in size to the carrier element 5 or the temperature sensor 6 carried by the carrier element 5. The carrier element 5 is a sensor board or printed circuit board which is equipped with conductor tracks for the electrical transmission of sensor signals from the temperature sensor 6. According to the exemplary embodiment, the conductor tracks lead into contact regions 13, which can be seen in particular in FIG. 3. The spring elements 8 surround the carrier element 5 in these contact regions 13, so that, in this way, not only is the carrier element 5 held in tangential contact with the relevant contact element 3, but, at the same time, the sensor signals emitted by the temperature sensor 6 can be transmitted to the control unit 10 via the spring elements 8 and the supply lines 9.

The carrier element 5 and the temperature sensor 6 are equipped with a sheath 14 that is both heat-conducting and electrically insulating. The sheath 14 is designed in such a way that only the previously mentioned contact regions 13 are left out. This means that the sheath 14 encloses the sensor board or circuit board and thus the carrier element 5 and the temperature sensor 6 together. For this purpose, the sheath 14 is a plastic sheath which is applied by overmolding the carrier element 5 including the temperature sensor 6. In fact, the invention at this point relies on a thermoplastic, as already described in the introduction to the description. In detail, the plastic is a plastic compound with added fillers.

The fillers used are those which simultaneously ensure good thermal conductivity and electrical insulation of the thermoplastic in question, e.g., in the form of aluminum oxide or boron nitride, as already described in the introduction. This means that the sheath 14 made of plastic can still be processed by injection molding, and at the same time ensures that the sheath 14 in effect does not hinder the heat conduction from the contact element 3 to the temperature sensor 6 in the region of the contact surface 7. Nevertheless, the sheath 14 provides the necessary electrical insulation in this region, so that no problems are observed at this point.

In fact, the sheath 14 according to the exemplary embodiment has a material thickness which is generally less than 1 mm and in particular 0.5 mm or less. As a result, a heat flow emanating from the contact element 3 can pass through the sheath 14 directly and in a short time, and reach the temperature sensor 6 in the region of the contact surface 7 almost without delay. As a result, any overheating of the contact element 3 is immediately detected with the aid of the temperature sensor 6 and reported to the control unit 10 as described. The control unit 10 can then, for example, reduce the charging current at the contact elements 3 or even switch it off completely.

In the context of FIGS. 4A to 4C, a variant is shown in which the carrier element 5 is equipped with two opposing temperature sensors 6. In this way, the two adjacent contact elements 3 can be monitored with regard to their temperature by using a single carrier element 5 with the two temperature sensors 6. The sequence of FIGS. 4A to 4C shows the simple assembly of the carrier element 5 including the two temperature sensors 6, which for this purpose are inserted into the spring elements 8 anchored in the housing. As a result, the desired electrical connection is created between the spring elements 8 and the associated contact regions 13 of the conductor track of the carrier elements 5, so that, in this case too, the two temperature sensors 6 can independently monitor the associated contact elements 3 for any overheating. This means that, in this case too, the two contact elements 3 are monitored separately from one another with the aid of the associated temperature sensors 6, and any overheating is reported to the control unit 10 as described.

### LIST OF REFERENCE SIGNS

1 Charging socket
2 Housing
3 Electrical contact elements (DC)
4 Electrical contact elements (AC)
5,6 Temperature-monitoring device
5 Planar carrier element
6 Temperature sensor
7 Contact surface
8 Spring element
9 Electrical lines
10 Control unit
11 Insulating collar
3, 11 Assembly arrangement
12 Insertion opening
13 Contact region
14 Sheath

1. A plug connector part for mechanical and electrical connection to a mating plug connector part for a motor vehicle-side charging socket for coupling to a charging plug as components of an electrical charging infrastructure for electric or hybrid motor vehicles,
the plug connector part comprising:
a housing and an electrical contact element located in the housing, and
a temperature-monitoring device having a planar carrier element and at least one temperature sensor located on the planar carrier element, the planar carrier element being attached to the contact element, wherein the carrier element is thermally coupled to the contact element with at least one spring element, and
wherein the carrier element is positioned tangentially on the contact element.

2. The plug connector part according to claim 1, wherein the contact element has on a housing side an insulating collar with an insertion opening for the carrier element.

3. The plug connector part according to claim 2, wherein the insertion opening is adapted in size to the temperature sensor such that when the carrier element is installed in the insertion opening, there are no uncovered regions of the contact element.

4. The plug connector part according to claim 1, wherein the carrier element has a sensor board with conductor tracks for electrical transmission of sensor signals.

5. The plug connector part according to claim 4, wherein the carrier element has a sheath which is both heat-conducting and electrically insulating.

6. The plug connector part according to claim 5, wherein the sheath encloses the sensor board and the temperature sensor together.

7. The plug connector part according to claim 5, wherein the sheath is designed as a plastic sheath.

8. The plug connector part according to claim 7, wherein the plastic sheath includes a duroplast or a thermoplastic material with added filler.

9. The plug connector part according to claim 5, wherein the sheath has a material thickness of less than 1 mm.

10. The plug connector part according to claim 1, wherein the carrier element is equipped with two opposing temperature sensors that monitor two respective contact elements.

11. The plug connector part according to claim 5, wherein the sheath has a material thickness of 0.5 mm or less.

12. The plug connector part according to claim 1, wherein the contact element is cylindrical and the carrier element is flexibly attached to the contact element.

13. The plug connector part according to claim 1, wherein the carrier element is configured as a rectangular strip and the carrier element is located in a region of a contact surface of the carrier element with the contact element.

14. The plug connector part according to claim 4, further comprising a control unit that monitors a temperature of the contact element, wherein the at least one spring element is configured as an electrical contact that transmits sensor signals from the sensor board to the control unit.
